(19) United States
(12) Patent Application Publication
(10) Pub. No.: US 2025/0043815 A1
(43) Pub. Date: Feb. 6, 2025

(54) CABLE CONNECTING DEVICE

(71) Applicant: HI-LEX Corporation, Hyogo (JP)

(72) Inventors: Shingo TAKEUCHI, Hyogo (JP); Tomoyoshi OKADA, Hyogo (JP)

(73) Assignee: HI-LEX Corporation, Hyogo (JP)

(21) Appl. No.: 18/788,199

(22) Filed: Jul. 30, 2024

(30) Foreign Application Priority Data
Jul. 31, 2023 (JP) 2023-124529

(51) Int. Cl. F16C 1/10; F16C 1/16

(52) U.S. Cl. CPC F16C 1/106; F16C 1/101; F16C 1/16; F16C 2326/08

(57) ABSTRACT

A cable connecting device includes a casing, a pinion gear, first and second sliders, a first output cable connected to the first slider, and second output cable connected to the second slider. The first slider includes a first rack portion and a first end connection portion, and the second slider includes a second rack portion and a second end connection portion. The first output cable is led out from the casing to one side in the movement direction, and the second output cable is led out from the casing to the other side in the movement direction.

### CROSS REFERENCE TO RELATED APPLICATIONS

This application claims the benefit of priority of Japanese Patent Application No. 2023-124529, filed on Jul. 31, 2023, the contents of which are incorporated by reference as if fully set forth herein in their entirety.

### TECHNICAL FIELD

The present invention relates to a cable connecting device.

### BACKGROUND ART

As a device that can move two cables (hereafter each referred to as “output cable”) in conjunction with the operation of one cable (hereafter referred to as “input cable”), Patent Literature (hereinafter, referred to as PTL) 1 discloses the following device. The device includes a case, a joint piece that slides within the case, one input cable connected to the joint piece, and two output cables connected to the joint piece. The device of PTL 1 is a seat reclining device in which unlock levers (hereinafter, each referred to as an operation target) connected to the two output cables are operated by the output cables, thereby unlocking to recline the seat.

In addition, PTLs 2 and 3 disclose devices in which two output cables are led out of a case in opposite directions.

### CITATION LIST

### Patent Literature

PTL 1
Japanese Patent Application Laid-Open No. 2017-26041
PTL 2
Japanese Patent Application Laid-Open No. 2017-115955
PTL 3
Japanese Patent Application Laid-Open No. 2021-110364

### SUMMARY OF INVENTION

### Technical Problem

In the device of PTL 1, the operation targets are positioned on both sides in the left-right direction of the seat so as to be spaced apart from each other, and the two output cables are led out in the same direction from the case and are routed to extend from the center of the lower part (on which the case is provided) of the seat toward the left and right sides of the seat (on which the operation targets are provided). In this case, while one of the output cables is routed to extend from the case located in the center of the lower part of the seat to one side of the seat in the left-right direction (for example, the right side), the other one of the output cables is needed to be turned around and routed in the opposite direction in the left-right direction to the other side of the seat after the cable is led out from the case to the one side of the seat. Therefore, it is necessary to bend the output cable at an acute angle to route the output cable. When two output cables are led out of a case in the same direction and one of the operation targets is located in a direction opposite to the direction in which the cables are led out, the degree of freedom in cable routing is low and the cable routing lengths differ, and therefore, it is necessary to adjust the amount of operation of the shorter cable to match the longer cable.

In the device of PTL 2, a belt is used to lead the two output cables out in the same direction, and stretching or rubbing of the belt may cause stroke loss or durability problems. In addition, a link member that rotates about a rotation axis is used in the device of PTL 3. In the case of the device of PTL 3, it is necessary to increase the length of the link member from the rotation shaft for increasing the stroke amount of the cable. However, when the length of the link member from the rotation shaft is increased, the size of the device itself would also increase.

An object of the present invention is to provide a cable connecting device that allows for high degree of freedom in cable routing, size reduction of the entire device, obtainment of a satisfactory amount of cable stroke, and improvement of durability.

### Solution to Problem

A cable connecting device of the present invention includes: a casing; a pinion gear supported relative to the casing in such a way that the pinion gear is rotatable about a rotation axis thereof; a first slider and a second slider configured to move along a predetermined movement direction in the casing; a first output cable with one end thereof connected to the first slider, and another end thereof connected to a first operation target; and a second output cable with one end thereof connected to the second slider, and another end thereof connected to a second operation target, in which the first slider includes a first rack portion and a first end connection portion, the first rack portion meshing with the pinion gear, the first end connection portion being a portion to which the one end of the first output cable is connected; the second slider includes a second rack portion and a second end connection portion, the second rack portion meshing with the pinion gear, the second end connection portion being a portion to which the one end of the second output cable is connected; the first slider is disposed opposite the second slider in a radial direction of the pinion gear with the pinion gear therebetween; and the first output cable is led out from the casing to one side in the movement direction, and the second output cable is led out from the casing to another side in the movement direction.

### Advantageous Effects of Invention

The cable connecting device of present invention allows for high degree of freedom in cable routing, size reduction of the entire device, obtainment of a satisfactory amount of cable stroke, and improvement of durability.

### BRIEF DESCRIPTION OF DRAWINGS

FIG. 1 schematically illustrates a state in which a first output cable is connected to a first operation target and a second output cable is connected to a second operation target in a cable connecting device according to an embodiment of the present invention;

FIG. 2 is an exploded perspective view of the cable connecting device according to the embodiment of the present invention;

FIG. 3 is a plan view of the cable connecting device according to the embodiment of the present invention with a second casing removed;

FIG. 4 is a perspective view of a first slider;

FIG. 5 is a plan view illustrating a state in which a first slider has moved in a second movement direction, and a second slider has moved in a first movement direction, from the state illustrated in FIG. 3;

FIG. 6 is a plan view illustrating a variation provided with a second input cable;

FIG. 7 is a plan view illustrating a state in which the first input cable is operated in the variation of FIG. 6;

FIG. 8 is a plan view illustrating a state in which the second input cable is operated in the variation of FIG. 6;

FIG. 9 is an exploded perspective view of a cable connecting device according to Embodiment 2 of the present invention;

FIG. 10 is a partial cross-sectional view of a second guide portion of a casing of the cable connecting device according to Embodiment 2, taken along movement direction;

FIG. 11 is a plan view of the cable connecting device according Embodiment 2 with a second casing removed;

FIG. 12 is a plan view illustrating a state in which the first slider has moved in the second movement direction, and the second slider has moved in the first movement direction, from the state illustrated in FIG. 11;

FIG. 13 is a cross-sectional view of the cable connecting device according to Embodiment 2 taken along line XIII-XIII in FIG. 11 while the first casing is closed by the second casing; and

FIG. 14 is a perspective view of the first slider of the cable connecting device according to Embodiment 2.

### DESCRIPTION OF EMBODIMENTS

Herein after, a cable connecting device according to an embodiment of the present invention will be described with reference to the drawings. Each embodiment described below is merely an example, and the cable connecting device of the present invention is not limited to the following embodiments.

Herein, the phrase “perpendicular to A” and similar phrases do not only refer to a direction completely perpendicular to A, but also refer to a direction approximately perpendicular to A. In addition, herein, the phrase “parallel to B” and similar the phrases do not only refer to a direction completely parallel to B, but also refer to a direction approximately parallel to B. Herein, the term “C-shape” and similar terms do not refer only to a perfect C-shape, but also refer to a shape that visually resembles a C-shape (approximately C-shape).

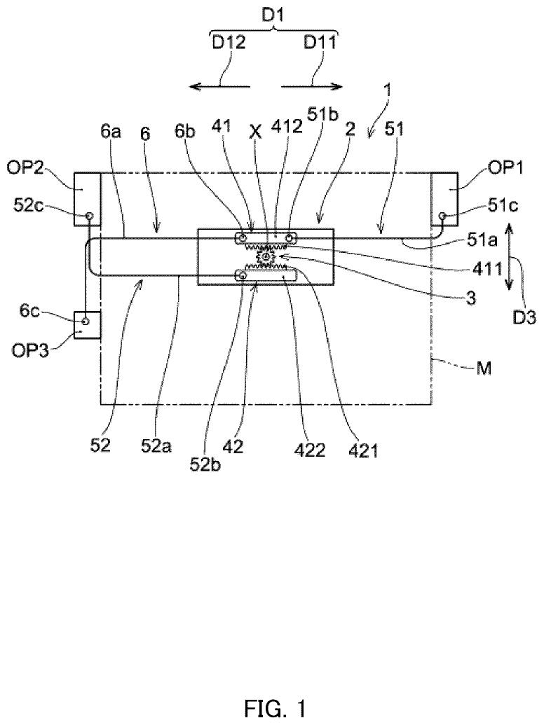

As illustrated in FIGS. 1 to 3, cable connecting device 1 of the present embodiment includes the following: casing 2; pinion gear 3 supported relative to casing 2 in such a way that pinion gear 3 is rotatable about rotation axis X; first slider 41 and second slider 42 each configured to move along a predetermined movement direction D1 within casing 2; first output cable 51 with one end thereof connected to first slider 41 and the other end thereof connected to first operation target OP1 (see FIG. 1); and second output cable 52 with one end thereof connected to second slider 42 and the other end thereof connected to second operation target OP2 (see FIG. 1). In the present embodiment, as described below in detail, first output cable 51 is led out from casing 2 to the one side (first movement direction D11) in movement direction D1, and second output cable 52 is led out from casing 2 to the other side (second movement direction D12) in movement direction D1, as illustrated in FIGS. 1 to 3. In addition, in the present embodiment, cable connecting device 1 includes input cable 6 for operating first output cable 51 and second output cable 52, as illustrated in FIGS. 1 to 3.

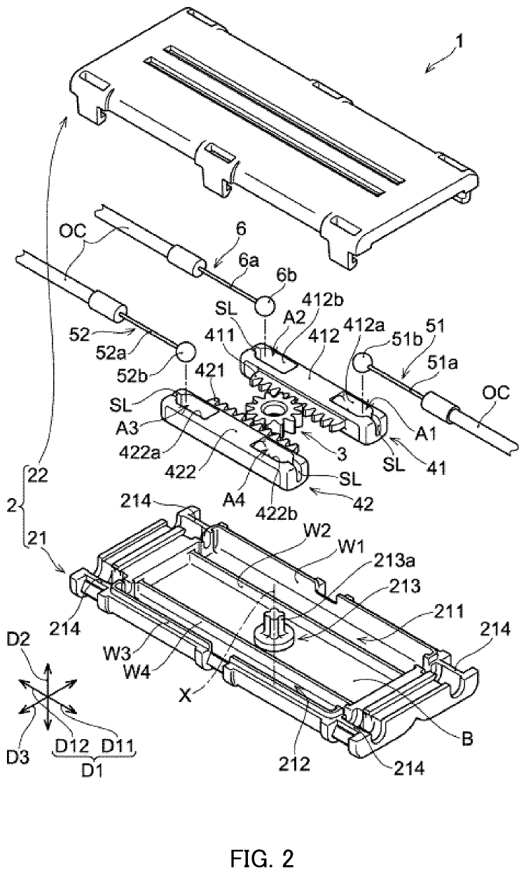

Herein, one side of movement direction D1, which is the direction in which first output cable 51 is led out from casing 2, is referred to as first movement direction D11. The other side of movement direction D1, which is the direction in which second output cable 52 is led out from casing 2, is referred to as second movement direction D12. First movement direction D11 and second movement direction D12 are collectively referred to as movement direction D1. In addition, in the present embodiment, rotation axis X of pinion gear 3 extends in a direction perpendicular to movement direction D1 (see FIG. 2); and the direction (in which rotation axis X of pinion gear 3 extends) is referred to as axial direction D2 of rotation axis X of pinion gear 3 (hereinafter simply referred to as axial direction D2). In addition, the direction perpendicular to both movement direction D1 and axial direction D2 is referred to as width direction D3 (the direction in which first slider 41 and second slider 42 are spaced apart from each other) of casing 2.

Cable connecting device 1 is a device that connects, inside casing 2, first output cable 51 with second output cable 52. Specifically, as illustrated in FIGS. 1 to 3, cable connecting device 1 connects first output cable 51 with second output cable 52 via first slider 41, pinion gear 3, and second slider 42. This configuration allows first output cable 51 and second output cable 52 to be operated in conjunction with each other, as described in detail below. In the present embodiment, first output cable 51 and second output cable 52 are operated in conjunction with each other by operating input cable 6, as described below.

Cable connecting device 1 may be used in any application but may be used, for example, in the following application as illustrated in FIG. 1: a plurality of operation targets, such as first operation target OP1 and second operation target OP2, are operated at once (substantially simultaneously) by a plurality of cables, such as first output cable 51 and second output cable 52. In the present embodiment, casing 2 is disposed in cable connecting device 1 in such a way that length L1 (not illustrated) of first output cable 51 extending from casing 2 to first operation target OP1 is substantially equal to length L2 (not illustrated) of second output cable 52 extending from casing 2 to second operation target OP2. Herein, length L1 of first output cable 51 being substantially equal to length L2 of second output cable 52 means that length L1 of first output cable 51 is 80 to 120% of length L2 of second output cable 52 (0.8×L2≤L1≤1.2× L2), preferably 90 to 110% (0.9× L2≤L1≤1.1×L2). However, the relationship between length L1 of first output cable 51 and length L2 of second output cable 51 does not have to fall in the above-described range.

In the present embodiment, cable connecting device 1 has the following configuration as illustrated in FIG. 1: first operation target OP1 and second operation target OP2 are provided on both sides of attachment target M with casing 2 in between. In the present embodiment, cable connecting device 1 is applied to an operating device for a reclining mechanism of a vehicle seat. Specifically, on both the left and right sides of the vehicle seat (namely an attachment target, hereinafter referred to as seat M, and in FIG. 1, only the seat portion of seat M is indicated by a two-dot chain line), locking portions (namely, first and second operation targets, hereinafter referred to as locking portions OP1, OP2) which lock the reclining mechanisms of seat M are provided. Cable connecting device 1 also includes operation portion OP3 for operating locking portions OP1 and OP2. Operation portion OP3 is connected to first slider 41 by input cable 6. With above configuration, when operation portion OP3 is operated, input cable 6 is pulled, and first slider 41 and second slider 42 move in conjunction with each other via pinion gear 3, as described below. First output cable 51 and second output cable 52 are thus operated in conjunction with each other, and the lock portions OP1 and OP2 are operated simultaneously. As a result, the locked state of seat M caused by the locking portions OP1 and OP2 is released, and seat M can be reclined. The application of cable connecting device 1 is not limited to an operating device for a reclining mechanism of a seat, and cable connecting device 1 may also be applied to other mechanisms, such as a hood opening and closing mechanism.

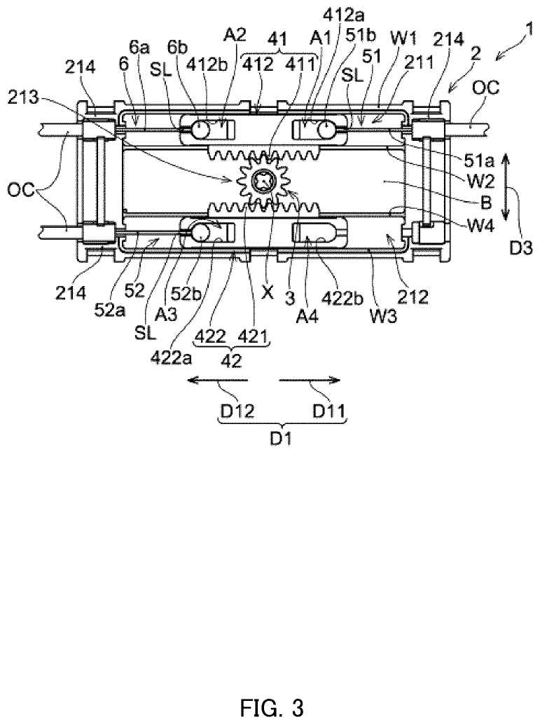

As illustrated in FIG. 3, casing 2 houses pinion gear 3, first slider 41 and second slider 42. Casing 2 rotatably supports pinion gear 3 and also guides first slider 41 and second slider 42 in movement direction D1. Casing 2 may have any shape and structure as long as casing 2 can house pinion gear 3, first slider 41, and second slider 42. In the present embodiment, casing 2 includes first casing 21 and second casing 22 as illustrated in FIG. 2. Specifically, casing 2 includes first casing 21, which is provided on one side (the lower side in FIG. 2) in axial direction D2 of rotation axis X of pinion gear 3 and rotatably supports pinion gear 3; and second casing 22, which is provided on the other side (upper side in FIG. 2) in axial direction D2 of rotation axis X of pinion gear 3. In the present embodiment, first casing 21 is configured to house pinion gear 3, first slider 41, and second slider 42. Second casing 22 functions as a lid for closing first casing 21.

In the present embodiment, casing 2 (first casing 21) includes first guide portion 211 that guides first slider 41 in movement direction D1, and second guide portion 212 that guides second slider 42 in movement direction D1, as illustrated in FIGS. 2 and 3. Casing 2 (first casing 21) also includes gear support portion 213 (see FIG. 2) which rotatably supports pinion gear 3. In addition, casing 2 includes cable lead-out portions 214 through which cables such as first output cable 51, second output cable 52, and input cable 6 are led out from the inside of casing 2 to the outside.

First guide portion 211 guides first slider 41 in movement direction D1, and second guide portion 212 guides second slider 42 in movement direction D1. First guide portion 211 and second guide portion 212 may have any shapes and structures as long as the guide portions can respectively guide first slider 41 and second slider 42 in movement direction D1. In the present embodiment, first guide portion 211 is configured to guide first slider 41 in movement direction D1 by a pair of guide walls W1 and W2 spaced apart by a predetermined distance in width direction D3, as illustrated in FIGS. 2 and 3. More specifically, first guide portion 211 is defined by guide walls W1 and W2, bottom portion B of first casing 21, and an inner surface (not illustrated) in second casing 22—the inner surface faces bottom portion B of first casing 21 in axial direction D2. In a similar manner, second guide portion 212 is configured to guide second slider 42 in movement direction D1 by a pair of guide walls W3 and W4 spaced apart by a predetermined distance in width direction D3. Second guide portion 212 is defined by guide walls W3 and W4, bottom portion B of first casing 21, and the inner surface of second casing 22.

Bottom portion B of first casing 21 is located at the bottom of first casing 21, which has a shape of a substantially rectangular box with one side open. Bottom portion B faces first slider 41, second slider 42, and pinion gear 3 in axial direction D2. In the present embodiment, bottom portion B is configured by a plane extending along movement direction D1 and width direction D3, but the bottom portion does not have to be a plane. In the present embodiment, guide walls W1 and W3 are respectively configured by side walls that extend along movement direction D1 and define portions of the outer periphery of casing 2 (first casing 21). Guide walls W2 and W4 are wall portions extending along movement direction D1 and disposed so as to be respectively spaced apart from guide walls W1 and W3 toward the inside of casing 2 in width direction D3. In the present embodiment, guide walls W2 and W4 are configured in such a way that the height thereof from bottom portion B in axial direction D2 is smaller than the height from bottom portion B to a below-described first rack portion 411 of first slider 41 (or second rack portion 421 of second slider 42). This configuration allows first rack portion 411 and second rack portion 421 to straddle guide walls W2 and W4 in width direction D3, respectively, and mesh with the pinion gear 3, as illustrated in FIG. 3.

Gear support portion 213 supports pinion gear 3 so that the pinion gear 3 is rotatable about rotation axis X. Gear support portion 213 is provided between first guide portion 211 and second guide portion 212 in width direction D3. As illustrated in FIG. 2, gear support portion 213 includes shaft member 213a that protrudes from bottom portion B in axial direction D2 of rotation axis X.

Cable lead-out portions 214 are portions through which cables such as first output cable 51, second output cable 52, and input cable 6 are led out from the inside of casing 2 to the outside. In the present embodiment, cable lead-out portion 214 is configured in such a way that the end of outer casing OC—through which a cable such as first output cable 51, second output cable 52, or input cable 6 passes—can be attached to the cable lead-out portion as illustrated in FIGS. 2 and 3.

As illustrated in FIG. 1, first output cable 51 is a cable with one end thereof connected to first slider 41 and the other end thereof connected to first operation target OP1. Second output cable 52 is a cable with one end thereof connected to second slider 42 and the other end thereof connected to second operation target OP2. First output cable 51 is operated in movement direction D1 as first slider 41 moves in movement direction D1 by a predetermined driving force. Second output cable 52 is operated in movement direction D1 as second slider 42 moves in movement direction D1 by a predetermined driving force. In the present embodiment, when input cable 6 is operated by operation portion OP3, first slider 41 is moved in second movement direction D12 (to the left in FIG. 1). As a result, first output cable 51 is pulled in second movement direction D12 by first slider 41 so that first output cable 51 is pulled into casing 2. First operation target OP1 is thus operated by first output cable 51. On the other hand, when first slider 41 moves in second movement direction D12 (to the left in FIG. 1), second slider 42 moves in first movement direction D11 (to the right in FIG. 1) via pinion gear 3. As a result, second cable 52 connected to second slider 42 is pulled in first movement direction D11 by second slider 41 so that second output cable 52 is pulled into casing 2. Second operation target OP2 is thus operated by second output cable 52.

As illustrated in FIG. 1, first output cable 51 is routed along a predetermined routing path that links first slider 41 and first operation target OP1. Second output cable 52 is routed along a predetermined routing path that links second slider 42 and second operation target OP2. In the present embodiment, first output cable 51 and second output cable 52 are housed in outer casings OC and are routed along predetermined routing paths.

As illustrated in FIG. 1, first output cable 51 includes cable main body 51a, cable end 51b provided at one end of cable main body 51a, and cable end 51c provided at the other end of cable main body 51a. In the present embodiment, cable end 51b at the one end of first output cable 51 is engaged with and connected to first slider 41. Cable end 51c at the other end of first output cable 51 is engaged with and connected to first operation target OP1. In a similar manner, second output cable 52 includes cable main body 52a, cable end 52b provided at one end of cable main body 52a, and cable end 52c provided at the other end of cable main body 52a. Cable end 52b at the one end of second output cable 52 is engaged with and connected to second slider 42. Cable end 52c at the other end of second output cable 52 is engaged with and connected to second operation target OP2.

Any inner cable of a known control cable may be used as first output cable 51 and second output cable 52. In the drawings, cable ends 51b and 52b are illustrated as spherical, but other shapes other than spherical may also be employed.

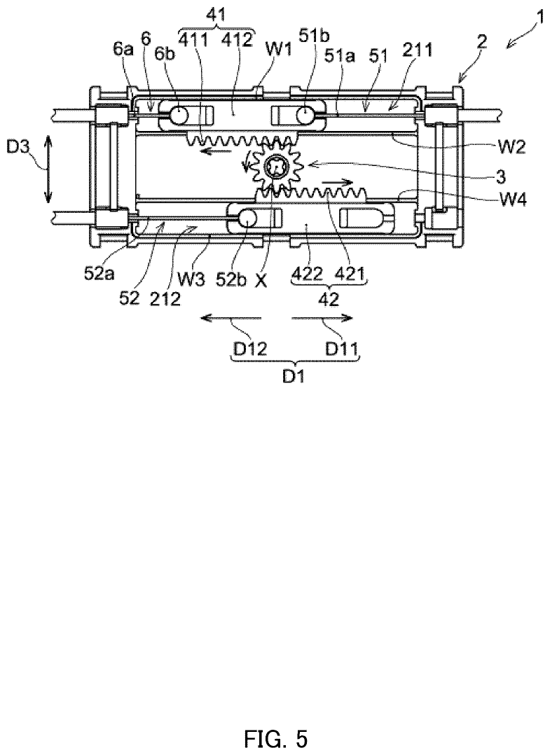

Input cable (first input cable) 6 is a cable capable of operating first slider 41 in order to operate first output cable 51 and second output cable 52. In the present embodiment, one end of input cable 6 is connected to first slider 41, and the other end of input cable 6 is connected to operation portion OP3, as illustrated in FIG. 1. As described in detail below, by operating input cable 6 toward the other side (second movement direction D12) in movement direction D1, first output cable 51 is operated toward the other side (second movement direction D12) in movement direction D1, and second output cable 52 is operated toward the one side (first movement direction D11) in movement direction D1. Specifically, when input cable 6 is operated by operation portion OP3, first slider 41 is moved in second movement direction D12, as illustrated in FIG. 5. First output cable 51 is thus pulled in second movement direction D12 by first slider 41. The movement of first slider 41 in second movement direction D12 causes pinion gear 3 to rotate about rotation axis X. The rotation causes second slider 42 meshing with pinion gear 3 to move in first movement direction D11. Second output cable 52 connected to second slider 42 is thus pulled in first movement direction D11. As described above, by operating input cable 6, first output cable 51 and second output cable 52 are operated in conjunction with each other to move in directions opposite to each other.

As illustrated in FIG. 1, input cable 6 is routed along a predetermined routing path that links first slider 41 and operation portion OP3. In the present embodiment, input cable 6 is housed in outer casing OC, and is routed through outer casing OC along the predetermined routing path linking first slider 41 and operation portion OP3.

As illustrated in FIG. 1, input cable 6 includes cable main body 6a, cable end 6b provided at one end of cable main body 6a, and cable end 6c provided at the other end of cable main body 6a. In the present embodiment, cable end 6b at the one end of input cable 6 is engaged with and connected to first slider 41. Cable end 6c at the other end of input cable 6 is engaged with and connected to operation portion OP3.

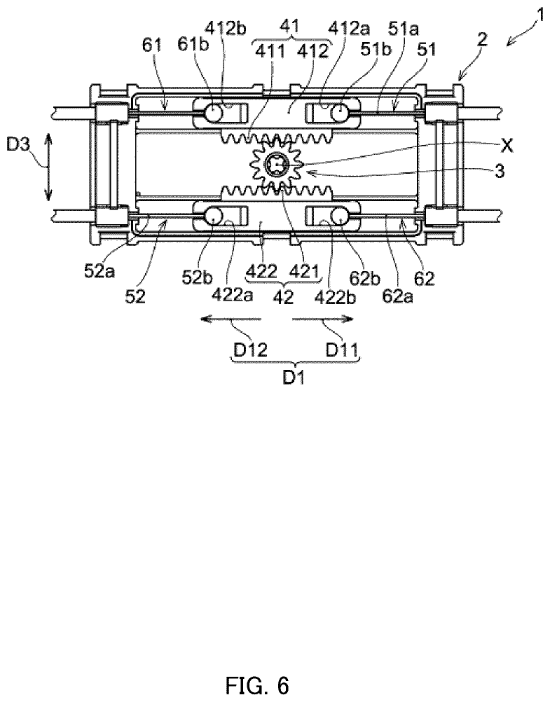

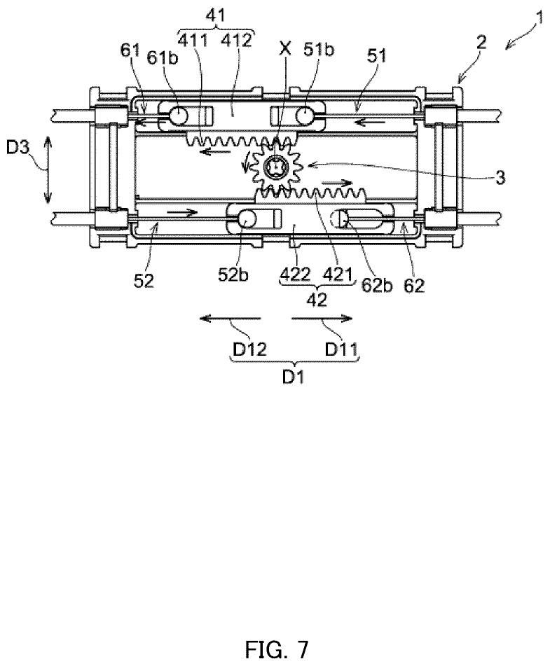

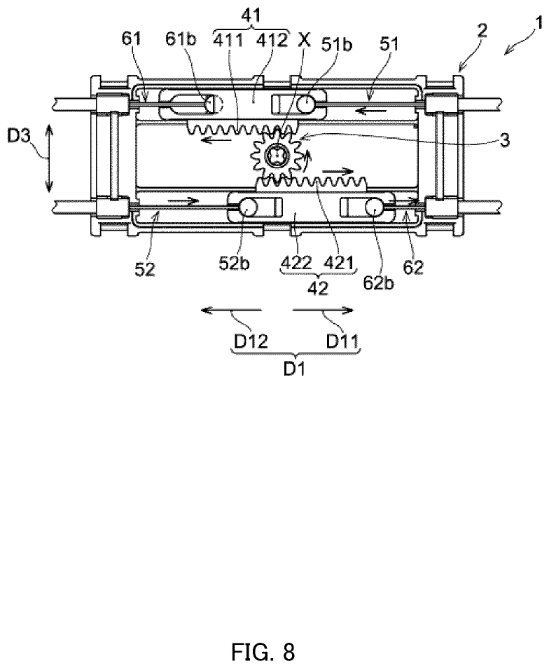

As illustrated in FIGS. 6 to 8, cable connecting device 1 may include two input cables, namely first input cable 61 and second input cable 62, as a variation of the present embodiment. Specifically, as illustrated in FIG. 6, first input cable 61 is connected to first slider 41, and second input cable 62 capable of operating second slider 42 is connected to second slider 42. In the case of the present variation, by operating first input cable 61 toward the other side (second movement direction D12, to the left in FIG. 6) in movement direction D1, first output cable 51 is operated toward the other side (second movement direction D12) in movement direction D1, and second output cable 52 is operated toward the one side (first movement direction D11) in movement direction D1, as illustrated in FIG. 7. On the other hand, by operating second input cable 62 toward the one side (first movement direction D11, to the right in FIG. 6) in movement direction D1, first output cable 51 is operated toward the other side (second movement direction D12) in movement direction D1, and second output cable 52 is operated toward the one side (first movement direction D11) in movement direction D1, as illustrated in FIG. 8. In the present variation, both first output cable 51 and second output cable 52 can be operated not only by first input cable 61 but also by second input cable 62.

As another variation, the cable connecting device may include, in place of an input cable, a drive section (such as a motor) which rotates pinion gear 3 about rotation axis X. In this case, pinion gear 3 is rotated about rotation axis X by the drive section, and the resulting rotational force drives first slider 41 and second slider 42. As a result, first output cable 51 and second output cable 52 are operated.

Pinion gear 3 meshes with first slider 41 and second slider 42 to move first slider 41 and second slider 42 in conjunction with each other. Specifically, teeth provided on the outer periphery of pinion gear 3 mesh with first rack portion 411 (described below) of first slider 41 and second rack portion 421 (described below) of second slider 42. When one of first slider 41 and second slider 42 moves to the one side in movement direction D1, the other one of first slider 41 and second slider 42 moves to the other side in movement direction D1, and first slider 41 and second slider 42 move in opposite directions to each other. Pinion gear 3 is supported so as to be rotatable about rotation axis X by gear support portion 213 of casing 2. In the present embodiment, pinion gear 3 is supported so as to rotatable relative to shaft member 213a in a center portion of casing 2 located at the center in movement direction D1 and in width direction D3.

First slider 41 and second slider 42 are moved in movement direction D1 within casing 2 by a predetermined driving force. First slider 41 operates first output cable 51 connected to first slider 41 in movement direction D1. In the present embodiment, not only first output cable 51 but also input cable 6 is connected to first slider 41, as illustrated in FIG. 3. As illustrated in FIG. 5, as first slider 41 receives a force from input cable 6 to move in movement direction D1, first output cable 51 is operated in movement direction D1. Second slider 42 operates second output cable 52 connected to second slider 42 in movement direction D1. In the present embodiment, the linear motion of first slider 41 in movement direction D1 caused by the operating force applied to input cable 6 is transmitted to second slider 42 via pinion gear 3, thereby moving second slider 42 in movement direction D1, as illustrated FIG. 5. As a result, second output cable 52 is operated in movement direction D1.

As illustrated in FIGS. 2 to 4, first slider 41 includes first rack portion 411 that meshes with pinion gear 3, and first end connection portion 412 to which one end (cable end 51b) of first output cable 51 is connected. In a similar manner, second slider 42 includes second rack portion 421 that meshes with pinion gear 3, and second end connection portion 422 to which one end (cable end 52b) of second output cable 52 is connected.

First rack portion 411 and second rack portion 421 mesh with pinion gear 3 to convert the linear motion of first slider 41 or second slider 42 into the rotational motion of pinion gear 3, or convert the rotational motion of pinion gear 3 into the linear motion of first slider 41 or second slider 42. In the present embodiment, first rack portion 411 engages with pinion gear 3 to convert the linear motion of first slider 41 in movement direction D1 into the rotational motion of pinion gear 3. Second rack portion 421 engages with pinion gear 3 to convert the rotational motion of pinion gear 3 into the linear motion of second slider 42 in movement direction D1.

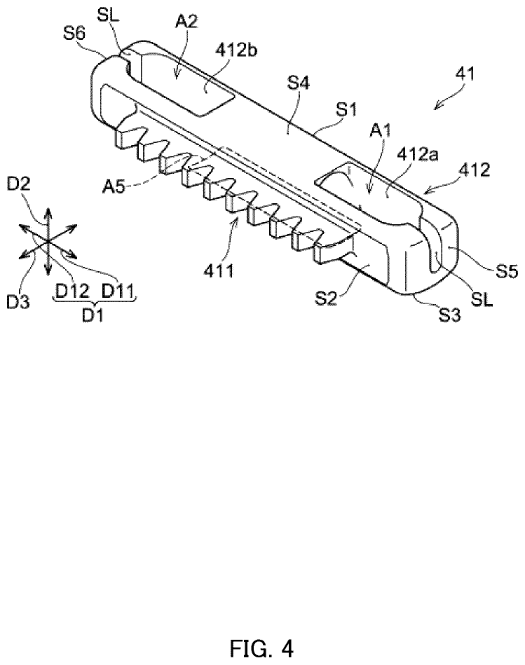

First rack portion 411 and second rack portion 421 each have a plurality of teeth along movement direction D1 and mesh with the teeth of pinion gear 3. In the present embodiment, as illustrated FIGS. 3 and 4, first rack portion 411 protrudes toward second slider 42 from a side surface (second side surface S2 described below) in first end connection portion 412—the side surface faces second slider 42 in width direction D3. Specifically, as illustrated in FIG. 3, first rack portion 411 protrudes beyond guide wall W2 in width direction D3 at a position higher than the height of guide wall W2 from bottom portion B, and engages with pinion gear 3. Second rack portion 421 protrudes toward first slider 41 from a side surface in second end connection portion 422—the side surface faces first slider 41 in width direction D3. As illustrated in FIG. 3, second rack portion 421 protrudes beyond guide wall W4 in width direction D3 at a position higher than the height of guide wall W4 from bottom portion B, and engages with pinion gear 3.

One end (cable end 51b) of first output cable 51 is connected to first end connection portion 412. In the present embodiment, first end connection portion 412 is the main body portion (in the present embodiment, a portion including the below-described first end housing portion 412a and second end housing portion 412b) of first slider 41 excluding first rack portion 411. One end (cable end 52b) of second output cable 52 is connected to second end connection portion 422. In the present embodiment, second end connection portion 422 is the main body portion (a portion including the below-described third end housing portion 422a and fourth end housing portion 422b) of second slider 42 excluding second rack portion 421.

In the present embodiment, first end connection portion 412 and second end connection portion 422 are guided in movement direction D1 within casing 2. Specifically, first end connection portion 412 is guided by first guide portion 211, and second end connection portion 422 is guided by second guide portion 212, and the end connection portions move in movement direction D1. The first end connection portion and the second end connection portion may have any shapes and structures. In the present embodiment, first end connection portion 412 and second end connection portion 422 are formed in a substantially rectangular parallelepiped shape having a predetermined length in movement direction D1, as illustrated in FIGS. 2 and 4. More specifically, as illustrated FIG. 4, first end connection portion 412 includes the following: first side surface S1 facing guide wall W1 in width direction D3; second side surface S2 facing guide wall W2 in width direction D3, and first rack portion 411 protrudes from second side surface S2; third side surface S3 (lower surface) facing bottom portion B of first casing 21; fourth side surface S4 (upper surface) facing the inner surface of second casing 22; first end surface S5 on the first moving direction D11 side; and second end surface S6 on the second moving direction D12 side. Second end connection portion 422 includes first to fourth side surfaces, a first end surface, and a second end surface in a similar manner. In the present embodiment, first slider 41 and the second slider 42 have the same shape.

In the present embodiment, as illustrated in FIGS. 2 to 4, first end connection portion 412 includes first end housing portion 412a in which one end (cable end 51b) of first output cable 51 is housed. First end housing portion 412a is provided on one side of first end connection portion 412 in movement direction D1 (the first movement direction D11 side). Specifically, first end housing portion 412a is formed from a recess having a size capable of housing cable end 51b, and is configured to be able to engage with cable end 51b in movement direction D1. In the present embodiment, first end connection portion 412 includes opening A1 in fourth side surface S4, and is configured so that first end housing portion 412a can house cable end 51b through opening A1. Slit SL is formed in first end surface S5 of first end connection portion 412 so as to communicate with the space in first end housing portion 412a in such a way that cable main body 51a extending from cable end 51b of first output cable 51 can pass through the slit. In the present embodiment, opening A1 opens at fourth side surface S4 with a predetermined length in movement direction D1, and slit SL extends on first end surface S5 in axial direction D2, as illustrated in FIGS. 2 to 4.

In the present embodiment, as illustrated in FIGS. 2 to 4, first end connection portion 412 includes second end housing portion 412b in which one end (cable end 6b) of input cable 6 is housed. Second end housing portion 412b is provided on the other side of first end connection portion 412 in movement direction D1 (the second movement direction D12 side). Specifically, second end housing portion 412b is formed from a recess having a size capable of housing cable end 6b, and is configured to be able to engage with cable end 6b in movement direction D1. In the present embodiment, first end connection portion 412 includes opening A2 in fourth side surface S4, and is configured so that second end housing portion 412b can house cable end 6b through opening A2. Slit SL is formed in second end surface S6 of first end connection portion 412. In the present embodiment, first end connection portion 412 includes opening A5 (see dashed line in FIG. 4) in third side surface S3 (lower surface) facing bottom portion B of casing 2 (first casing 21). Providing an opening A5 can reduce the contact area between first slider 41 and bottom portion B of casing 2, thereby reducing the sliding resistance of first slider 41. Second end connection portion 422 of second slider 42 includes third end housing portion 422a, fourth end housing portion 422b, openings A3 and A4, and slit SL, in the same manner as first end connection portion 412 of first slider 41. In FIG. 3, cable end 52b of second output cable 52 is housed in third end housing portion 422a, but no cable is connected to fourth end housing portion 422b. In the variation illustrated in FIGS. 6 to 8, a cable end of second input cable 62 is connected to fourth end housing portion 422b.

In the present embodiment, the space within first end housing portion 412a and the space within second end housing portion 412b are in communication with each other in movement direction D1 (third end housing portion 422a and fourth end housing portion 422b also have a similar configuration). In the variation illustrated in FIGS. 6 to 8, when second slider 42 moves in first movement direction D11, cable end 62b of second input cable 62 (which is not being operated) enters the communication space, thereby preventing interference between second slider 42 and cable end 62b, as illustrated in FIG. 7. (In a similar manner, interference between cable end 61b of first input cable 61 (which is not being operated) and first slider 41 is also prevented, as illustrated in FIG. 8.) The communicating space between the space within first end housing portion 412a and the space within second end housing portion 412b is covered by fourth side surface S4 (see FIG. 4) provided in a roof shape between opening A1 and opening A2. This configuration can restrict the movement of cable end 62b located in the communication space in FIG. 7 in a direction away from second end connection portion 422 (in a similar manner, the movement of cable end 61b in a direction away from first end connection portion 412 is also restricted, as illustrated in FIG. 8).

In the present embodiment, first slider 41 is disposed opposite second slider 42 in the radial direction (width direction D3) of pinion gear 3 with pinion gear 3 therebetween. As a result, first slider 41 and second slider 42 move in opposite directions to each other in movement direction D1. Therefore, first output cable 51 connected to first slider 41 and second output cable 52 connected to second slider 42 can be operated in opposite directions to each other in movement direction D1. First output cable 51 can be thus led out from casing 2 to the one side (first movement direction D11) in movement direction D1, and second output cable 52 can be led out from casing 2 to the other side (second movement direction D12) in movement direction D1. More specifically, first output cable 51 and second output cable 52 can be led out in opposite directions from casing 2 while simultaneously performing a pulling operation to pull first output cable 51 and second output cable 52 into casing 2. In this case, for example, when first operation target OP1 and second operation target OP2 are disposed on opposite sides of casing 2, there is no need to bend one of the two output cables at an acute angle for routing, thereby increasing the freedom of cable routing. In addition, when a rack-and-pinion mechanism using pinion gear 3, first slider 41, and second slider 42 operates first output cable 51 and second output cable 52 at a predetermined stroke amount in the present embodiment, the entire device can be made smaller than when a link member that rotates about a rotation axis is used as in PTL 3. (When a rotating link member as in PTL 3 is used, it is necessary to increase the radius of rotation for increasing the stroke amount, which increases the size of the entire device.) As described above, the present embodiment employs a rack-and-pinion mechanism using pinion gear 3, first slider 41, and second slider 42 thus uses no materials that are prone to stroke loss or durability deterioration due to repeated movements, such as belts that are prone to stretching and friction as in PTL 2. Therefore, in the present embodiment, the durability of the device is increased.

In the present embodiment, first end connection portion 412 is disposed outside in the radial direction (width direction D3) of pinion gear 3 as compared to first rack portion 411, and second end connection portion 422 is disposed outside in the radial direction (width direction D3) of pinion gear 3 as compared to second rack portion 421, as illustrated in FIGS. 2 and 3. In this case, first end connection portion 412, first rack portion 411, pinion gear 3, second rack portion 421, and second end connection portion 422 are arranged in this order in width direction D3, as illustrated in FIG. 3. The thickness of casing 2 of cable connecting device 1 thus can be reduced in axial direction D2.

### Embodiment 2

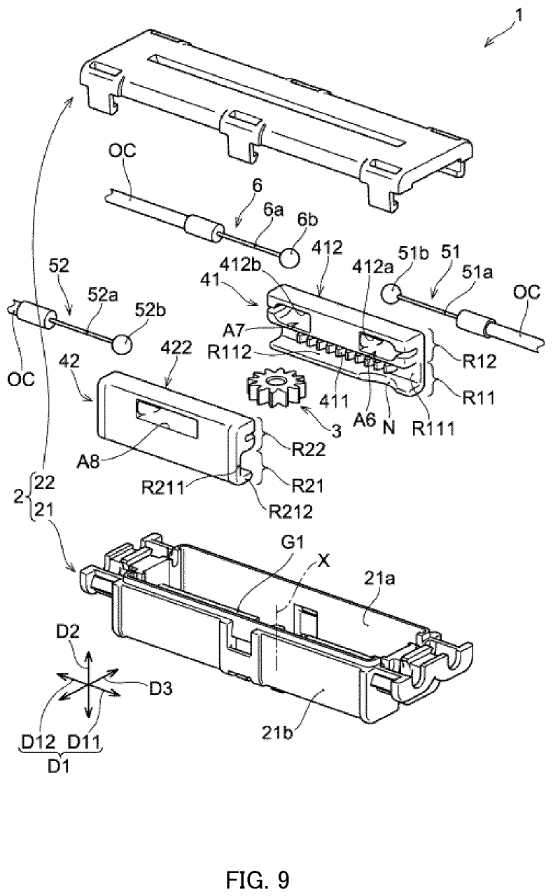

Hereinafter, a cable connecting device according to Embodiment 2 will be described with reference to FIGS. 9 to 14. In the following description, the description of the matters in common with Embodiment 1 described above will be omitted, and the differences will be mainly described. Furthermore, all of the matters described in Embodiment 1 can be applied to the cable connecting device of Embodiment 2 as long as the object of the invention can be achieved, and the configuration of the present embodiment may be used in combination with the contents described in Embodiment 1. The effects obtained by the configuration described in Embodiment 1 can also be obtained in Embodiment 2 as long as Embodiment 2 has the same configuration.

As illustrated in FIG. 9, cable connecting device 1 according to Embodiment 2 includes casing 2, pinion gear 3, first slider 41, second slider 42, first output cable 51, and second output cable 52, in a similar manner as in Embodiment 1. Cable connecting device 1 according to Embodiment 2 also includes input cable 6. Cable connecting device 1 according to Embodiment 2 may also include a second input cable in a similar manner as in Embodiment 1.

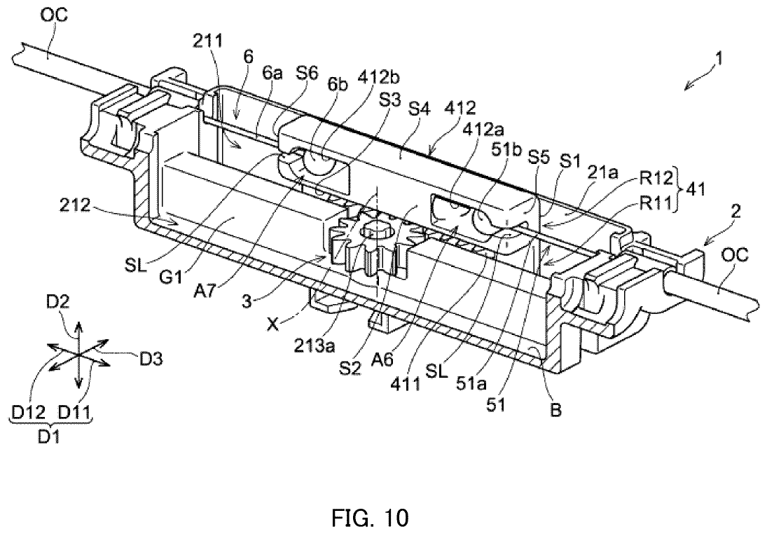

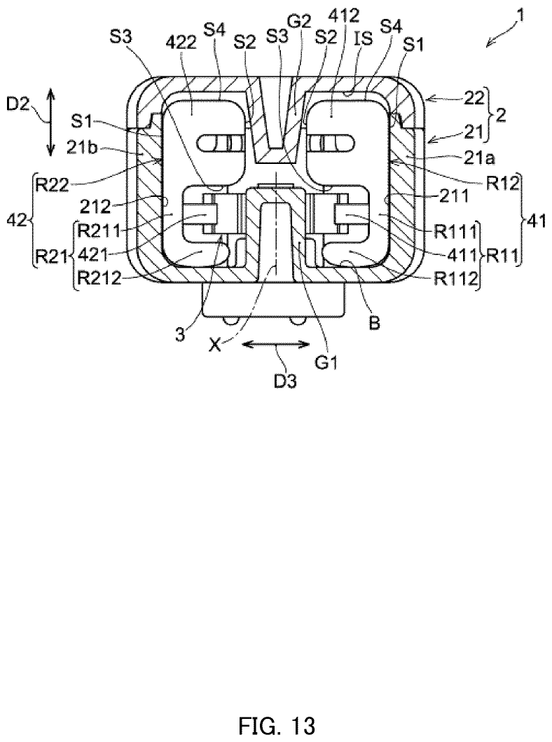

In the present embodiment, casing 2 includes first casing 21 and second casing 22, as illustrated in FIGS. 9 and 13. As illustrated in FIG. 13, first casing 21 includes first guide portion 211 that guides first slider 41 and second guide portion 212 that guides second slider 42. As illustrated in FIGS. 10 to 13, first casing 21 includes guide rail G1 extending along movement direction D1 on bottom portion B, and guide rail G1 separates first guide portion 211 and second guide portion 212. As illustrated in FIG. 13, second casing 22 includes, on inner surface IS thereof facing bottom portion B of first casing 21, guide rail G2 extending along movement direction D1 to guide first slider 41 and second slider 42 in movement direction D1. First guide portion 211 is defined by side wall 21a of first casing 21, guide rails G1 and G2, bottom portion B of first casing 21, and inner surface IS of second casing 22. In a similar manner, second guide portion 212 is defined by side wall 21b of first casing 21, guide rails G1 and G2, bottom portion B of first casing 21, and inner surface IS of second casing 22.

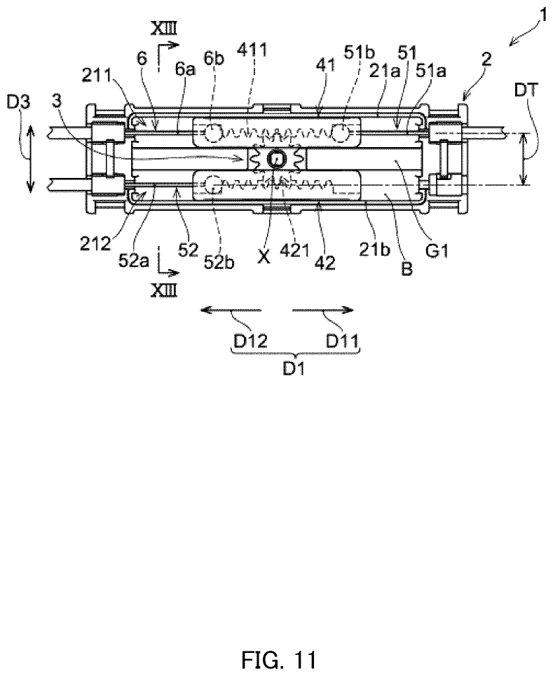

As illustrated in FIG. 13, guide rail G1 of first casing 21 protrudes at a predetermined height (lower than the below-described first partition wall (third side wall S3)) from bottom portion B. In addition, as illustrated in FIG. 10, guide rail G1 includes a recess, in center portion in movement direction D1, for housing pinion gear 3 so that pinion gear 3 is rotatably about rotation axis X. As illustrated in FIG. 11, guide rail G1 is configured in such a way that the width of guide rail G1 in width direction D3 is smaller than the diameter of pinion gear 3, and the teeth of pinion gear 3 protrude from both sides of guide rail G1 in width direction D3. As illustrated in FIG. 13, guide rail G2 of second casing 22 protrudes at a predetermined height from inner surface IS of second casing 22 toward bottom portion B in axial direction D2.

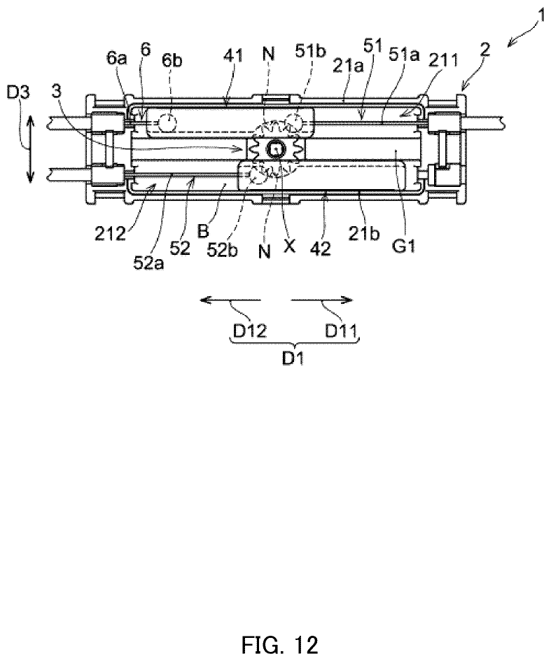

The movement of cable connecting device 1 of Embodiment 2 is basically the same as that of the cable connecting device of Embodiment 1. Specifically, as illustrated in FIG. 12, when input cable 6 is operated by operation portion OP3, first slider 41 is moved in second movement direction D12 (see FIG. 1), and first output cable 51 is pulled in second movement direction D12. The movement of first slider 41 in second movement direction D12 causes pinion gear 3 to rotate about rotation axis X. The rotation causes second slider 42 meshing with pinion gear 3 to move in first movement direction D11, as illustrated in FIG. 12. Second output cable 52 connected to second slider 42 is thus pulled in first movement direction D11. As described above, by operating input cable 6, first output cable 51 and second output cable 52 are operated in conjunction with each other to move in directions opposite to each other.

In cable connecting device 1 of the present embodiment, the following are the same as in Embodiment 1: first slider 41 is disposed opposite second slider 42 in the radial direction (width direction D3) of pinion gear 3 with pinion gear 3 therebetween; and first output cable 51 is led out from casing 2 to the one side (first movement direction D11) in movement direction D1, and second output cable 52 is led out from casing 2 to the other side (second movement direction D12) in movement direction D1.

As described above, first slider 41 and second slider 42 move to sides opposite to each other in movement direction D1, also in the present embodiment. Therefore, first output cable 51 connected to first slider 41 and second output cable 52 connected to second slider 42 can be operated in opposite directions to each other in movement direction D1. First output cable 51 can be thus led out from casing 2 to the one side (first movement direction D11) in movement direction D1, and second output cable 52 can be led out from casing 2 to the other side (second movement direction D12) in movement direction D1. In this case, for example, when first operation target OP1 and second operation target OP2 are disposed on opposite sides of casing 2, there is no need to bend one of the two output cables at an acute angle for routing, thereby increasing the freedom of cable routing. In addition, when a rack-and-pinion mechanism using pinion gear 3, first slider 41, and second slider 42 operates first output cable 51 and second output cable 52 at a predetermined stroke amount in the present embodiment, the entire device can be made smaller than when a link member that rotates about a rotation axis is used. As described above, the present embodiment employs a rack-and-pinion mechanism using pinion gear 3, first slider 41, and second slider 42 thus uses no materials that are prone to stroke loss or durability deterioration due to repeated movements, such as belts that are prone to stretching and friction. Therefore, in the present embodiment, the durability of the device is increased.

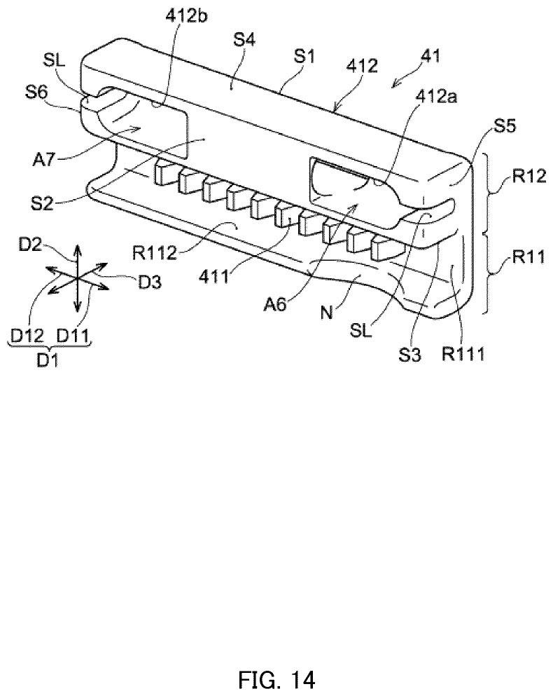

In addition, the present embodiment has the following configuration as illustrated in FIGS. 13 and 14: first slider 41 includes first rack forming region R11 provided with first rack portion 411, and first end connection region R12 provided with first end connection portion 412; and first end connection region R12 is disposed so as to superpose first rack forming region R11 on one side in axial direction D2 of rotation axis X of pinion gear 3. In a similar manner, second slider 42 includes second rack forming region R21 provided with second rack portion 421 and second end connection region R22 provided with second end connection portion 422, and second end connection region R22 is disposed so as to superpose second rack forming region R21 on the one side in axial direction D2 of rotation axis X of pinion gear 3.

As described above, in first slider 41, first rack forming region R11 (provided with first rack portion 411) and first end connection region R12 (provided with first end connection portion 412) are disposed so as to be aligned in axial direction D2, not in width direction D3 (that is, disposed at the positions in such a way that first rack forming region R11 is coincide with first end connection region R12 when viewed in axial direction D2). In a similar manner, in second slider 42, second rack forming region R21 (provided with second rack portion 421) and second end connection region R22 (provided with second end connection portion 422) are disposed so as to be aligned in axial direction D2. Therefore, even using a rack-and-pinion mechanism does not increase the size of casing 2 in width direction D3, thereby reducing the size of casing 2. In this case, distance (see FIG. 11) DT in width direction D3 between first output cable 51 (led out from one side of casing 2 in movement direction D1) and second output cable 52 (led out from the other side of casing 2 in movement direction D1) is smaller than the distance in width direction D3 between first output cable 51 and second output cable 52 of Embodiment 1. Therefore, it is possible to bring the routing path of first output cable 51 to first operation target OP1 close to the routing path of second output cable to second operation target OP2, and the length of first output cable 51 and the length of second output cable 52 can also be set to similar lengths.

First slider 41 may have any shape and structure as long as first slider 41 includes first rack forming region R11 and first end connection region R12, and first end connection region R12 is disposed so as to superpose first rack forming region R11 on one side in axial direction D2. In the present embodiment, first slider 41 includes first end connection region R12 in a substantially rectangular parallelepiped shape, and first rack forming region R11 extending from first end connection region R12 toward bottom portion B of casing 2 in axial direction D2. In the present embodiment, first slider 41 is configured such that the dimension thereof in axial direction D2 is larger than the dimension thereof in width direction D3 when viewed in movement direction D1, as illustrated in FIG. 13. More specifically, first end connection region R12 and first rack forming region R11 are configured to have approximately the same dimension in axial direction D2 and approximately the same dimension in width direction D3. The shape and structure of second slider 42 may be similar to that of first slider 41.

First rack forming region R11 is a region, where first rack portion 411 is formed, in first slider 41. In the present embodiment, first rack forming region R11 includes the following: rack forming wall portion R111 that contacts side wall (guide wall) 21a located opposite pinion gear 3 in width direction D3 across first slider 41, and first rack portion 411 is formed on rack forming wall portion R111; first rack portion 411 that is provided along movement direction D1 and protrudes from rack forming wall portion R111 toward pinion gear 3 in width direction D3; and bottom wall R112 provided so as to contact bottom portion B of casing 2. In the present embodiment, rack forming wall portion R111 is a portion extended in the axial direction D2 from first side wall S1 (described below) of first end connection region R12. In the present embodiment, rack forming wall portion R111 and first side wall S1, as continued surfaces, are in surface contact with side wall 21a over a wide area; therefore, even when a force is applied to first slider 41 at a position offset from the center in the axial direction D2, first slider 41 can be moved stably. In the present embodiment, rack forming wall portion R111 and bottom wall R112 are provided in a substantially L-shape when viewed in movement direction D1. In a space surrounded by rack forming wall portion R111, bottom wall R112, and the below-described first partition wall (third side wall S3), first rack portion 411 protrudes and extends from rack forming wall portion R111 in width direction D3. In a similar manner as first rack forming region R11, second rack forming region R21 of second slider 42 includes rack forming wall portion R211, second rack portion 421, and bottom wall R212.

In the present embodiment, bottom walls R112 and R212 each have notch N as illustrated in FIGS. 12 and 14. Notch Nis cut out in a shape that follows the outer periphery (the arc connecting the tips of the teeth of pinion gear 3) of pinion gear 3. With pinion gear 3 attached to casing 2, first slider 41 can be attached to casing 2 by moving first slider 41 toward bottom portion B so that the portion where notch N is provided matches the positions of the teeth of pinion gear 3.

In the present embodiment, as illustrated in FIG. 12, notch N of first slider 41 is provided on the end side of a region in bottom wall R112—the region shifted to the one side (the first movement direction D11 side) from the center of wall R112 in movement direction D1. On the other hand, notch N of second slider 42 is provided on the end side of a region in bottom wall R112—the region shifted to the other side (the second movement direction D12 side) from the center of bottom wall R112 in movement direction D1. When first slider 41 and second slider 42 are attached in such a way that the positions of notches N match the positions of the teeth of pinion gear 3, first slider 41 is positioned on the second movement direction D12 side as compared to the center of casing 2 in movement direction D1, and second slider 42 is positioned on the first movement direction D11 side s compared to the center of casing 2 in movement direction D1, as illustrated in FIG. 12. Notch N of first slider 41 and notch N of second slider 42 are at the same distance from the corresponding ends (specifically, first slider 41 and second slider 42 are identical members, and second slider 42 is first slider 41 rotated 180° about rotation axis X). Therefore, after first slider 41 and second slider 42 are attached to casing 2 in the positions illustrated in FIG. 12, first slider 41 and second slider 42 are accurately positioned with their positions aligned in movement direction D1 as illustrated in FIG. 11 by moving first slider 41 and second slider 42 to a central position in movement direction D1. This configuration facilitates positioning of first slider 41 and second slider 42 in movement direction D1. In addition, at the initial position as illustrated in FIG. 11 where first slider 41 and second slider 42 are not operated, notches N and pinion gear 3 are disposed at different positions in movement direction D1, and therefore, first slider 41 and second slider 42 are prevented from coming off first casing 21 during the assembly work.

First end connection region R12 of first slider 41 is a region that includes a portion including first end connection portion 412, to which one end (cable end 51b) of first output cable 51 is connected. In the present embodiment, first end connection region R12 is constituted by first end connection portion 412, but may include components other than the first end connection portion. In a similar manner, second end connection region R22 of second slider 42 is a region that includes a portion including second end connection portion 422, to which one end (cable end 52b) of second output cable 52 is connected.

First end connection portion 412 of first slider 41 of the present embodiment basically has the same configuration as first end connection portion 412 of Embodiment 1, except that the positions of the openings are different from those of openings A1 and A2 in Embodiment 1, and rack forming wall portion R111 of first rack forming region R11 is linked to first end connection portion 412, as described below. Specifically, first end connection portion 412 is formed in a substantially rectangular parallelepiped shape having a predetermined length in movement direction D1, as illustrated in FIG. 14. More specifically, first end connection portion 412 includes the following as illustrated in FIG. 14: first side surface S1 facing side wall (guide wall) 21a (see FIG. 13) in width direction D3; second side surface S2, which is the surface opposite to first side surface S1 in width direction D3; third side surface S3 (below-described first partition wall) which is a surface on the first rack forming region R11 side in axial direction D2 in first end connection portion 412; fourth side surface S4 (upper surface) facing inner surface IS (see FIG. 13) of second casing 22; first end surface S5 on the first movement direction D11 side; and second end surface S6 on the second movement direction D12 side. Second end connection portion 412 of second slider 42 has a shape and structure similar to those of first end connection portion 412.

In the present embodiment, first end connection portion 412 includes first end housing portion 412a and second end housing portion 412b, as illustrated in FIG. 14. In a similar manner, second end connection portion 422 includes a third end connection portion and a fourth end connection portion (not illustrated). First end housing portion 412a and second end housing portion 412b are in communication with each other in movement direction D1 (the third end housing portion and the fourth end housing portion also have a similar configuration).

In the present embodiment, first end connection region R12 (first end connection portion 412) includes openings A6 and A7 in the surface (second side surface S2) facing second end connection region R22 (second end connection portion 422), as illustrated in FIG. 10. In a similar manner, second end connection region R22 includes openings (not illustrated) in the surface facing first end connection region R12. In the present embodiment, cable end 51b of first output cable 51 is housed in first end housing portion 412a through opening A6. In addition, cable end 6b of input cable 6 is housed in second end housing portion 412b through opening A7.

The present embodiment has the following configuration: openings A6 and A7 are provided in the surface facing second end connection region R22; and by moving cable ends 51b and 6b from openings A6 and A7 in width direction D3, cable ends 51b and 6b are attached to first end housing portion 412a and second end housing portion 412b, respectively. First end housing portion 412a and second end housing portion 412b are covered from both sides in axial direction D2 by third side wall S3 and fourth side wall S4. For example, even when a force is applied to outer casing OC in axial direction D2 during the assembly process as illustrated in FIG. 10, cable ends 51b and 6b are thus prevented from coming off first end housing portion 412a and second end housing portion 412b. Therefore, during the process of assembling cable connecting device 1, cable ends 51b and 6b are prevented from coming off first slider 41, thereby improving the efficiency of assembly.

In addition, in the present embodiment, guide rail G2 is provided between first end connection region R12 of first slider 41 and second end connection region R22 of second slider 42, as illustrated in FIG. 13. In the present embodiment, guide rail G2 closes openings A6 and A7 of first end connection region R12 and the openings of second end connection region R22. This configuration prevents cable ends 51b and 6b housed in first end housing portion 412a and second end housing portion 412b of first end connection region R12, and cable end 52b housed in third end housing portion of second end connection region R22 from coming off the openings. “Closing” an opening does not necessarily mean sealing the opening, but rather it is sufficient to cover the opening while being spaced apart from the opening in such a way that there is only a gap not large enough for the cable end to come off the opening.

In first end surface S5 of first end connection portion 412, slit SL is formed so as to communicate with the space in first end housing portion 412a in such a way that cable main body 51a extending from cable end 51b of first output cable 51 can pass through the slit, as illustrated in FIG. 14. In a similar manner, slit SL is formed in second end surface S6 of first end connection portion 412 so as to communicate with the space in second end housing portion 412b in such a way that cable main body 6a extending from cable end 6b of input cable 6 can pass through the slit. In the present embodiment, first side surface S1 of first end connection portion 412 includes an opening (refer to opening A8 provided in second end connection portion 422 in FIG. 9). Providing openings can reduce the contact area between first slider 41 (or second slider 42) and side wall 21a (or 21b) of first casing 21, thereby reducing the sliding resistance of first slider 41 and second slider 42.

In the present embodiment, first rack forming region R11 and first end connection region R12 are configured such that first partition wall (third side surface S3) extending perpendicular to rotation axis X of pinion gear 3 separates an internal space of first end connection portion 412 from a space in which first rack portion 411 is provided, as illustrated FIGS. 13 and 14. In a similar manner, second rack forming region R21 and second end connection region R22 are configured such that a second partition wall (third side surface) separates an internal space of second end connection portion 422 from a space in which second rack portion 421 is provided As illustrated in FIG. 13, the first partition wall and the second partition wall are disposed so as to face one of the end surfaces of pinion gear 3 for restricting the movement of pinion gear 3 to one side (the upward direction in FIG. 13) in axial direction D2 of rotation axis X within a predetermined range. In this case, even when pinion gear 3 moves in axial direction D2 of rotation axis X relative to casing 2, the first partition wall and the second partition wall restrict the movement of pinion gear 3 within a predetermined range, thereby preventing pinion gear 3 from coming off shaft member 213a.

Although the embodiments of the present invention have been described above, the present invention is not limited to the above embodiments. The above-described embodiments mainly describe an invention having the following configuration.

(1) A cable connecting device, including:
a casing;
a pinion gear supported relative to the casing in such a way that the pinion gear is rotatable about a rotation axis thereof;
a first slider and a second slider configured to move along a predetermined movement direction in the casing;
a first output cable with one end thereof connected to the first slider, and another end thereof connected to a first operation target; and
a second output cable with one end thereof connected to the second slider, and another end thereof connected to a second operation target, in which
the first slider includes a first rack portion and a first end connection portion, the first rack portion meshing with the pinion gear, the first end connection portion being a portion to which the one end of the first output cable is connected,
the second slider includes a second rack portion and a second end connection portion, the second rack portion meshing with the pinion gear, the second end connection portion being a portion to which the one end of the second output cable is connected,
the first slider is disposed opposite the second slider in a radial direction of the pinion gear with the pinion gear therebetween, and
the first output cable is led out from the casing to one side in the movement direction, and the second output cable is led out from the casing to another side in the movement direction.

(2) The cable connecting device according to (1), in which:
a first input cable configured to operate the first slider is connected to the first slider; and
when the first input cable is operated toward the other side in the movement direction, the first output cable is operated toward the other side in the movement direction, and the second output cable is operated toward the one side in the movement direction.

(3) The cable connecting device according to (1) or (2), in which:
a second input cable configured to operate the second slider is connected to the second slider; and
when the first input cable is operated toward the other side in the movement direction, or the second input cable is operated toward the one side in the movement direction, the first output cable is operated toward the other side in the movement direction, and the second output cable is operated toward the one side in the movement direction.

(4) The cable connecting device according to any one of (1) to (3), in which:

The cable connecting device according to claim 1, wherein: the first end connection portion is disposed outside in the radial direction of the pinion gear relative to the first rack portion; and the second end connection portion is disposed outside in the radial direction of the pinion gear relative to the second rack portion.

(5) The cable connecting device according to any one of (1) to (4), in which:
the first slider includes
   a first rack forming region provided with the first rack portion, and
   a first end connection region provided with the first end connection portion; the first end connection region is disposed so as to superpose the first rack forming region on one side in an axial direction of the rotation axis of the pinion gear;
the second slider includes
   a second rack forming region provided with the second rack portion, and
   a second end connection region provided with the second end connection portion; and
the second end connection region is disposed so as to superpose the second rack forming region on the one side in the axial direction of the rotation axis of the pinion gear.

(6) The cable connecting device according to any one of (1) to (5), in which:
the first rack forming region and the first end connection region are configured such that a first partition wall extending perpendicular to the rotation axis of the pinion gear separates an internal space of the first end connection portion from a space in which the first rack portion is provided;
the second rack forming region and the second end connection region are configured such that a second partition wall extending perpendicular to the rotation axis of the pinion gear separates an internal space of the second end connection portion from a space in which the second rack portion is provided; and
the first partition wall and the second partition wall are disposed to face one of end surfaces of the pinion gear for restricting movement of the pinion gear to the one side in the axial direction of the rotation axis within a predetermined range.

(7) The cable connecting device according to any one of (1) to (6), in which:
the casing includes a first casing provided on the one side in the axial direction of the rotation axis of the pinion gear and a second casing provided on another side in the axial direction of the rotation axis of the pinion gear, the first casing rotatably supporting the pinion gear;
the first end connection region includes an opening in a surface facing the second end connection region;
the second end connection region includes an opening in a surface facing the first end connection region; and
the second casing includes, between the first end connection region and the second end connection region, a guide rail extending along the movement direction so as to guide the first slider and the second slider in the movement direction and to close the opening of the first end connection region and the opening of the second end connection region.

### REFERENCE SIGNS LIST

1 Cable connecting device
2 Casing
21 First casing
21a Side wall of first casing
21b Side wall of first casing
211 First guide portion
212 Second guide portion
213 Gear support portion
213a Shaft member
214 Cable lead-out portion
22 Second casing
3 Pinion gear
41 First slider
411 First rack portion
412 First end connection portion
412a First end housing portion
412b Second end housing portion
42 Second slider
421 Second rack portion
422 Second end connection portion
422a Third end housing portion
422b Fourth end housing portion
51 First output cable
51a Cable main body
51b, 51c Cable end
52 Second output cable
52a Cable main body
52b, 52c Cable end
6 Input cable
6a Cable main body
6b, 6c Cable end
61 First output cable
61b Cable end
62 Second input cable
62b Cable end
A1, A2, A3, A4, A5, A6, A7, A8 Opening
B Bottom portion of first casing
D1 Movement direction
D11 First movement direction
D12 Second movement direction
D2 Axial direction
D3 Width direction
DT Distance in width direction between first output cable 51 and second output cable 52
G1, G2 Guide rail
IS Inner surface of second casing
M Attachment target (seat)
N Notch
OC Outer casing
OP1 First operation target (locking portion)
OP2 Second operation target (locking portion)
OP3 Operation portion
R11 First rack forming region
R111 Rack forming wall portion
R112 Bottom wall
R12 First end connection region
R21 Second rack forming region
R211 Rack forming wall portion
R212 Bottom wall
R22 Second end connection region
S1 First side surface
S2 Second side surface
S3 Third side surface
S4 Fourth side surface
S5 First end surface
S6 Second end surface
SL Slit
W1, W2, W3, W4 Guide wall
X Rotation axis

1. A cable connecting device, comprising:
a casing;
a pinion gear supported relative to the casing in such a way that the pinion gear is rotatable about a rotation axis thereof;
a first slider and a second slider configured to move along a predetermined movement direction in the casing;
a first output cable with one end thereof connected to the first slider, and another end thereof connected to a first operation target; and
a second output cable with one end thereof connected to the second slider, and another end thereof connected to a second operation target, wherein
the first slider includes a first rack portion and a first end connection portion, the first rack portion meshing with the pinion gear, the first end connection portion being a portion to which the one end of the first output cable is connected,
the second slider includes a second rack portion and a second end connection portion, the second rack portion meshing with the pinion gear, the second end connection portion being a portion to which the one end of the second output cable is connected,
the first slider is disposed opposite the second slider in a radial direction of the pinion gear with the pinion gear therebetween, and
the first output cable is led out from the casing to one side in the movement direction, and the second output cable is led out from the casing to another side in the movement direction.

2. The cable connecting device according to claim 1, wherein:
a first input cable configured to operate the first slider is connected to the first slider; and
when the first input cable is operated toward the other side in the movement direction, the first output cable is operated toward the other side in the movement direction, and the second output cable is operated toward the one side in the movement direction.

3. The cable connecting device according to claim 2, wherein:
a second input cable configured to operate the second slider is connected to the second slider; and
when the first input cable is operated toward the other side in the movement direction, or the second input cable is operated toward the one side in the movement direction, the first output cable is operated toward the other side in the movement direction, and the second output cable is operated toward the one side in the movement direction.

4. The cable connecting device according to claim 1, wherein:
the first end connection portion is disposed outside in the radial direction of the pinion gear relative to the first rack portion; and
the second end connection portion is disposed outside in the radial direction of the pinion gear relative to the second rack portion.

5. The cable connecting device according to claim 1, wherein:
the first slider includes
a first rack forming region provided with the first rack portion, and
a first end connection region provided with the first end connection portion;
the first end connection region is disposed so as to superpose the first rack forming region on one side in an axial direction of the rotation axis of the pinion gear;
the second slider includes
a second rack forming region provided with the second rack portion, and
a second end connection region provided with the second end connection portion; and
the second end connection region is disposed so as to superpose the second rack forming region on the one side in the axial direction of the rotation axis of the pinion gear.

6. The cable connecting device according to claim 5, wherein:
the first rack forming region and the first end connection region are configured such that a first partition wall extending perpendicular to the rotation axis of the pinion gear separates an internal space of the first end connection portion from a space in which the first rack portion is provided;
the second rack forming region and the second end connection region are configured such that a second partition wall extending perpendicular to the rotation axis of the pinion gear separates an internal space of the second end connection portion from a space in which the second rack portion is provided; and
the first partition wall and the second partition wall are disposed to face one of end surfaces of the pinion gear for restricting movement of the pinion gear to the one side in the axial direction of the rotation axis within a predetermined range.

7. The cable connecting device according to claim 5, wherein:
the casing includes a first casing provided on the one side in the axial direction of the rotation axis of the pinion gear and a second casing provided on another side in the axial direction of the rotation axis of the pinion gear, the first casing rotatably supporting the pinion gear;
the first end connection region includes an opening in a surface facing the second end connection region;
the second end connection region includes an opening in a surface facing the first end connection region; and
the second casing includes, between the first end connection region and the second end connection region,
a guide rail extending along the movement direction so as to guide the first slider and the second slider in the movement direction and to close the opening of the first end connection region and the opening of the second end connection region.
